(19) United States
(12) Patent Application Publication
(10) Pub. No.: US 2021/0286221 A1
(43) Pub. Date: Sep. 16, 2021

(54) LIQUID CRYSTAL DISPLAY PANEL

(71) Applicant: Shenzhen China Star Optoelectronics Semiconductor Display Technology Co., Ltd., Shenzhen, Guangdong (CN)

(72) Inventors: Galatu SURI, Shenzhen, Guangdong (CN); Zhiqing SHI, Shenzhen, Guangdong (CN); Zhengyu FENG, Shenzhen, Guangdong (CN)

(73) Assignee: Shenzhen China Star Optoelectronics Semiconductor Display Technology Co., Ltd., Shenzhen, Guangdong (CN)

(21) Appl. No.: 16/981,713

(22) PCT Filed: May 7, 2020
(86) PCT No.: PCT/CN2020/088928

§ 371 Date: Sep. 17, 2020

(30) Foreign Application Priority Data
Mar. 16, 2020 (CN) 202010179862.0

(51) Int. Cl. G02F 1/1362; G02F 1/1368

(52) U.S. Cl. CPC G02F 1/136218; G02F 1/136286; G02F 1/136222; G02F 1/1368

(57) ABSTRACT

A liquid crystal display panel is provided, which includes a first substrate, a second substrate disposed opposite to the first substrate, and a liquid crystal layer disposed between the first substrate and the second substrate. A pixel electrode layer is provided on the second substrate. The pixel electrode layer includes a plurality of pixel electrodes arranged in an array, and an auxiliary electrode is provided in a region between adjacent pixel electrodes.

### CROSS REFERENCE TO RELATED APPLICATIONS

The present application claims priority of a Chinese patent application filed on Mar. 16, 2020 with the National Intellectual Property Administration, application number 202010179862.0, titled “Liquid crystal display panel”, which is incorporated by reference in the present application in its entirety.

### FIELD OF INVENTION

The present application relates to the field of display technologies, and in particular to a liquid crystal display panel.

### BACKGROUND OF INVENTION

Liquid crystal display devices have advantages of light weight and thinness, no radiation, low power consumption, and vivid display colors, and are widely used in mobile phones, cameras, computer screens, televisions, and other electronic products, and are currently the mainstream display.

A structure of a liquid crystal display panel includes two layers of substrates and a liquid crystal layer sandwiched between the two layers of substrates. In addition, it also includes a polarizer layer, an encapsulation layer, and other structures. The two layers of substrates are provided with a structure such as a color filter layer and a light-shielding layer for adjusting display effect of the display panel. As an image display device, light transmittance of the display panel itself is an important factor affecting its display effect. However, presence of the polarizer layer, the color filter layer, and the light-shielding layer has a significant weakening effect on the light transmittance of the liquid crystal display panel. In particular, the light-shielding layer provided between different color resists of the color filter layer is opaque and has a wider distribution in the liquid crystal display panel, and hence has a greater adverse effect on both the light transmittance and an aperture ratio of the liquid crystal display panel. In order to prevent color mixing between the different color resists and improve a contrast ratio of the display panel in the conventional art, a structure of the light-shielding layer cannot be directly removed.

### Technical Problem

In the liquid crystal display panel of the conventional art, in order to prevent color mixing between different color resists and make the display panel have higher contrast ratio, a light-shielding layer structure is provided between the different color resists of the color filter layer. Since the light-shielding layer is opaque and has a wider distribution, it has a greater adverse effect on both the light transmittance and the aperture ratio of the liquid crystal display panel.

### SUMMARY OF INVENTION

### Technical Solution

In order to solve the above technical problems, the solutions provided in the present application are as follows.

A liquid crystal display panel provided by the present application includes a first substrate, a second substrate disposed opposite to the first substrate, and a liquid crystal layer disposed between the first substrate and the second substrate;

wherein the first substrate includes a first base substrate, and a common electrode disposed on the first base substrate and facing the second substrate;

wherein the second substrate includes a second base substrate, a side of the second base substrate facing the first substrate is provided with a thin film transistor layer and a pixel electrode layer provided on the thin film transistor layer, the pixel electrode layer includes a plurality of pixel electrodes arranged in an array, an auxiliary electrode is provided in a region between adjacent pixel electrodes, and the auxiliary electrode is configured to shield an electric field generated by the thin film transistor layer.

In the liquid crystal display panel of the present application, the first base substrate is made of a hard transparent material or a flexible transparent material.

In the liquid crystal display panel of the present application, the common electrode covers an entire display region of the liquid crystal display panel and is configured to provide an electric field effect for liquid crystal deflection in the liquid crystal layer.

In the liquid crystal display panel of the present application, the auxiliary electrode is disposed between the thin film transistor layer and the pixel electrode layer.

In the liquid crystal display panel of the present application, a transparent insulating layer is provided between the auxiliary electrode and the pixel electrode layer.

In the liquid crystal display panel of the present application, the transparent insulating layer is provided only in a region where the auxiliary electrode is positioned, without covering or partially covering a region where the pixel electrode is positioned.

In the liquid crystal display panel of the present application, the transparent insulating layer completely covers an entire display region of the liquid crystal display panel.

In the liquid crystal display panel of the present application, a color filter layer is provided between the thin film transistor layer and the pixel electrode layer, and the auxiliary electrode is provided between the color filter layer and the pixel electrode layer.

In the liquid crystal display panel of the present application, the color filter layer is provided with a plurality of color filter blocks arranged in an array, the color filter blocks correspond one-to-one with the pixel electrodes, and the auxiliary electrode is disposed in a region between adjacent color filter blocks.

In the liquid crystal display panel of the present application, an organic planarization layer is provided on a side of the color filter layer facing the pixel electrode layer, and the auxiliary electrode is provided between the organic planarization layer and the pixel electrode layer.

In the liquid crystal display panel of the present application, the first substrate further includes a color filter layer disposed between the first base substrate and the common electrode, the color filter layer includes a plurality of color filter blocks arranged in an array, and the color filter blocks correspond one-to-one with the pixel electrodes.

In the liquid crystal display panel of the present application, the thin film transistor layer includes a plurality of thin film transistors arranged in an array, and a plurality of scan lines and a plurality of data lines electrically connected to the thin film transistors.

In the liquid crystal display panel of the present application, the scan lines are electrically connected to gates of the thin film transistors to provide scan control signals for the thin film transistors, the data lines are electrically connected to sources of the thin film transistors to provide data signals for the thin film transistors, and drains of the thin film transistors are electrically connected to the pixel electrodes.

In the liquid crystal display panel of the present application, the scan lines and the gates of the thin film transistors are all positioned on a first metal layer close to the second base substrate, and the data lines, the sources and the drains of the thin film transistors are all disposed on a second metal layer away from the second base substrate.

In the liquid crystal display panel of the present application, the auxiliary electrode covers the thin film transistors, the scan lines, and the data lines along a thickness direction of the liquid crystal display panel.

In the liquid crystal display panel of the present application, a vertical projection of the auxiliary electrode on the pixel electrode layer and the pixel electrodes only partially overlap at edges, or completely do not overlapped.

In the liquid crystal display panel of the present application, the auxiliary electrode is made of a transparent conductive material.

In the liquid crystal display panel of the present application, the liquid crystal display panel further includes a backlight module provided on a back side of the liquid crystal display panel for providing a light source for the liquid crystal display panel.

The present application further provides a liquid crystal display panel, including a first substrate, a second substrate disposed opposite to the first substrate, a liquid crystal layer disposed between the first substrate and the second substrate, and a backlight module;

wherein the first substrate includes a first base substrate and a common electrode disposed on the first base substrate and facing the second substrate;

wherein the second substrate includes a second base substrate, a side of the second base substrate facing the first substrate is provided with a thin film transistor layer and a pixel electrode layer provided on the thin film transistor layer, the pixel electrode layer includes a plurality of pixel electrodes arranged in an array, an auxiliary electrode is provided in a region between adjacent pixel electrodes, the auxiliary electrode is disposed between the thin film transistor layer and the pixel electrode layer, the auxiliary electrode is configured to shield an electric field generated by the thin film transistor layer, and a transparent insulating layer is provided between the auxiliary electrode and the pixel electrode layer; and

wherein the backlight module is disposed on a side of the second substrate away from the first substrate, and is configured to provide a light source for the liquid crystal display panel.

In the liquid crystal display panel of the present application, the thin film transistor layer includes a plurality of thin film transistors arranged in an array, a plurality of scan lines and a plurality of data lines electrically connected to the thin film transistors, respectively, and the auxiliary electrode covers the thin film transistors, the scan lines, and the data lines along a thickness direction of the liquid crystal display panel.

### Beneficial Effect

The liquid crystal display panel provided by the present application includes a first substrate, a second substrate, and a liquid crystal layer disposed therebetween. Compared with the conventional art, the light-shielding layer structure in the first substrate is removed. Meanwhile, an auxiliary electrode is added to the second substrate, and the auxiliary electrode is configured to shield the electric field of the thin film transistor layer in the second substrate, so that the liquid crystal display panel has better light transmittance and aperture ratio while maintaining high contrast ratio.

### BRIEF DESCRIPTION OF FIGURES

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a schematic plane view of a liquid crystal display panel according to an embodiment of the present application.

FIG. 2 is a schematic structural diagram of a region A in a second substrate of the liquid crystal display panel shown in FIG. 1.

FIG. 3 is a cross-sectional view of the liquid crystal display panel shown in FIG. 2 taken along line A-A′ according to an embodiment.

FIG. 4 is a cross-sectional view of the liquid crystal display panel shown in FIG. 2 taken along line A-A′ according to another embodiment.

### DETAILED DESCRIPTION OF EMBODIMENTS

The following description of each embodiment, with reference to the accompanying drawings, is used to exemplify specific embodiments which may be carried out in the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention. In the drawings, components having similar structures are denoted by the same numerals.

An embodiment of the present application provides a liquid crystal display panel, which includes a first substrate and a second substrate. Compared with the conventional art, the light-shielding layer structure in the first substrate is removed. Meanwhile, an auxiliary electrode is added to the second substrate, and the auxiliary electrode is configured to shield the electric field of the thin film transistor layer in the second substrate, so that the liquid crystal display panel has better light transmittance and aperture ratio while maintaining high contrast ratio.

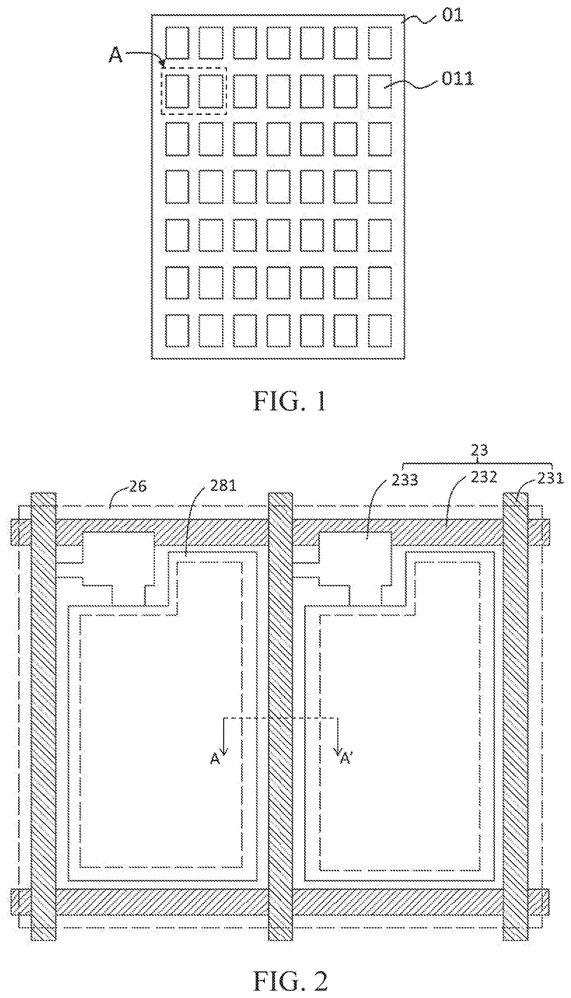

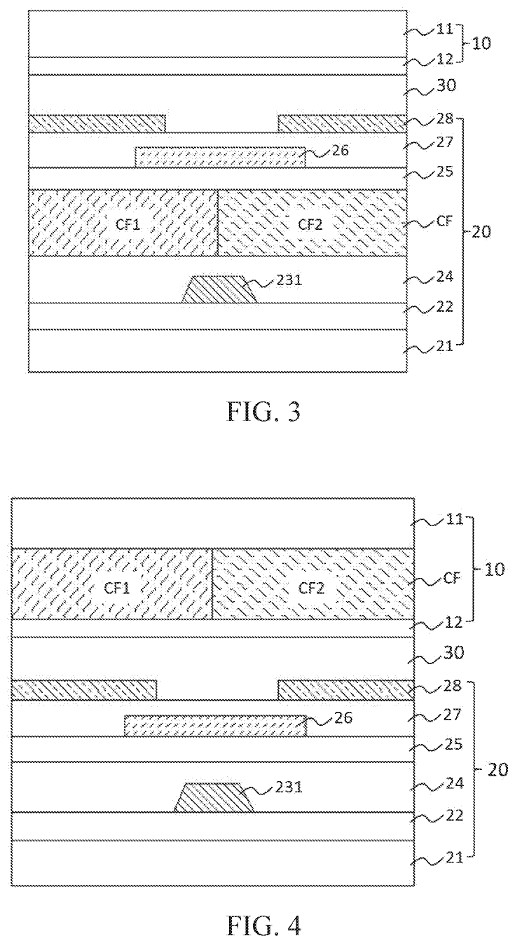

As shown in FIGS. 1 to 3, FIG. 1 is a schematic plane view of the liquid crystal display panel according to an embodiment of the present application, FIG. 2 is a schematic structural diagram of a region A in a second substrate of the liquid crystal display panel shown in FIG. 1, and FIG. 3 is a cross-sectional view of the liquid crystal display panel shown in FIG. 2 taken along line A-A′ according to an embodiment. The liquid crystal display panel 01 according to the embodiment of the present application includes a plurality of sub-pixel units 011. It should be noted that each of the sub-pixel units 011 is a basic display unit in the liquid crystal display panel 01, and the liquid crystal display panel 01 performs a display function through a combination of the sub-pixel units 011. Each of the sub-pixel units 011 respectively corresponds to one of color filter blocks in a color filter layer and one of pixel electrodes in a pixel electrode layer along a thickness direction of the liquid crystal display panel 01.

The liquid crystal display panel 01 includes a first substrate 10, a second substrate 20 disposed opposite to the first substrate 10, and a liquid crystal layer 30 disposed between the first substrate 10 and the second substrate 20. The liquid crystal layer 30 is filled with liquid crystals, and is a display gray scale adjustment unit of the liquid crystal display panel 01 to adjust a display of different gray scales of the liquid crystal display panel 01 from all white to all black.

According to an embodiment of the present application, the first substrate 10 includes a first base substrate 11, and a common electrode 12 disposed on the first base substrate 11 and facing the second substrate 20. The first base substrate 11 can be made of a hard transparent material, such as transparent glass, or flexible transparent material, such as polyimide. The common electrode 12 covers an entire display region of the liquid crystal display panel 01 and is configured to provide an electric field effect for the liquid crystal deflection in the liquid crystal layer 30. Alternatively, the common electrode 12 is made of a transparent conductive material, such as indium tin oxide, etc. When the liquid crystal display panel 01 performs the display function, the common electrode 12 is powered by an external power source to provide a constant electric field effect on the liquid crystal layer 30.

The second substrate 20 includes a second base substrate 21, a side of the second base substrate 21 facing the first substrate 10 is provided with a thin film transistor layer 23 and a pixel electrode layer 28 provided on the thin film transistor layer 23. The pixel electrode layer 28 includes a plurality of pixel electrodes 281 arranged in an array, an auxiliary electrode 26 is provided in a region between adjacent pixel electrodes 281, and the auxiliary electrode 26 is configured to shield an electric field generated by the thin film transistor layer 23.

It should be noted that the thin film transistor layer 23 includes multiple electronic components and traces, and is electrically connected to the pixel electrode layer 28 for controlling the electric field of the pixel electrode layer 28. The pixel electrode layer 28 provides an electric field effect on the liquid crystal layer 30, and controls the deflection of the liquid crystals in the liquid crystal layer 30 together with the common electrode 12, thereby adjusting the display effect of the liquid crystal display panel 01. The electronic components and traces in the thin film transistor layer 23 are conductive while generating an interference electric field, which causes the electric field generated by the pixel electrode layer 28 to be unstable. As a result, the deflection of the liquid crystals at a junction between two adjacent pixel electrodes 281 is chaotic, and the display contrast ratio of the liquid crystal display panel 01 decreases. In the present embodiment, by providing the auxiliary electrode 26 between the adjacent pixel electrodes 281, the electric field generated by the thin film transistor layer 23 can be shielded to improve the display contrast ratio of the liquid crystal display panel 01.

Alternatively, the second base substrate 21 can be made of a hard transparent material such as glass, or a flexible transparent material such as polyimide.

The thin film transistor layer 23 is disposed on the second base substrate 21 and includes a plurality of data lines 231, a plurality of scan lines 232, and a plurality of thin film transistors 233. The data lines 231 and the scan lines 232 are electrically connected to the thin film transistors 233, respectively. Specifically, each of the thin film transistors 233 includes a gate, a gate insulating layer 22, an active layer, and a source-drain layer. Wherein, the scan lines 232 are electrically connected to the gates of the thin film transistors 233 to provide scan control signals for the thin film transistors 233. The data lines 231 are electrically connected to sources of the thin film transistors 233 to provide data signals for the thin film transistors 233, and drains of the thin film transistors 233 are electrically connected to the pixel electrodes 281. Alternatively, each of the sub-pixel units 011 is correspondingly provided with one of the thin film transistors 233. The scan lines 232 and the gates of the thin film transistors 233 are all positioned on a first metal layer close to the second base substrate 21, and the data lines 231, the sources and the drains of the thin film transistors 233 are all disposed on a second metal layer away from the second base substrate 21.

Furthermore, a passivation layer 24, a color filter layer CF, an organic planarization layer 25, the auxiliary electrode 26, and a transparent insulating layer 27 are further provided between the thin film transistor layer 23 and the pixel electrode layer 28. Wherein, the passivation layer 24 and the transparent insulating layer 27 are both made of a transparent insulating material, such as silicon nitride, silicon oxide, etc. The passivation layer 24 is provided on the thin film transistor layer 23 to play the role of electrical insulation. The color filter layer CF is provided on the passivation layer 24, and includes a plurality of color filter blocks, such as a red filter block CF1 and a green filter block CF2 shown in FIG. 3. Each of the color filter blocks respectively corresponds to one of the sub-pixel units 011, and the color filter layer CF is configured to enable the liquid crystal display panel 01 to realize color display. The organic planarization layer 25 is provided on the color filter layer CF, and is configured to form a flat surface so that other devices can continue to be disposed on the organic planarization layer 25. The auxiliary electrode 26 and the transparent insulating layer 27 are disposed on the organic planarization layer 25, and the transparent insulating layer 27 completely covers the auxiliary electrode 26. The pixel electrode layer 28 is disposed on the transparent insulating layer 27 or the organic planarization layer 25.

The auxiliary electrode 26 is disposed in a region between two adjacent pixel electrodes 281, and is set along regions where the data lines 231, the scan lines 232, and the thin film transistors 233 are positioned to completely cover the data lines 231, the scan lines 232, and the thin film transistors 233. It should be understood that during a display process of the liquid crystal display panel 01, an upward electric field effect generated by the data lines 231, the scan lines 232, and the thin film transistors 233 due to energization will be shielded by the auxiliary electrode 26. Therefore, the influence of the electric field on the pixel electrode 281 is eliminated, and the display contrast ratio of the liquid crystal display panel is improved.

Alternatively, a vertical projection of the auxiliary electrode 26 on the pixel electrode layer 28 and the pixel electrodes 281 only partially overlap at edges, or completely do not overlap. It should be understood that when the vertical projection of the auxiliary electrode 26 on the pixel electrode layer 28 and the pixel electrodes 281 partially overlap at the edges, the auxiliary electrode 26 can completely shield the interference electric field generated by the thin film transistor layer 23. When the vertical projection of the auxiliary electrode 26 on the pixel electrode layer 28 and the pixel electrodes 281 completely do not overlap, the auxiliary electrode 26 plays a role of shielding the electric field, while eliminating its influence on the light transmittance of regions of the pixel electrodes 281.

Alternatively, the transparent insulating layer 27 can be provided only in a region where the auxiliary electrode 26 is positioned, without covering or partially covering a region where the pixel electrodes 281 are positioned; or the transparent insulating layer 27 completely covers an entire display region of the liquid crystal display panel 01.

Alternatively, the organic planarization layer 25 may not be provided on the color filter layer CF, and the auxiliary electrode 26 and the transparent insulating layer 27 can be directly provided on the color filter layer CF, to simplify an interlayer structure of the liquid crystal display panel 01.

According to another embodiment of the present application, as shown in FIGS. 1, 2, and 4, the first substrate 10 includes the first base substrate 11, and the color filter layer CF and the common electrode 12 are disposed on the first base substrate 11 and facing the second substrate 20. The first base substrate 11 can be made of hard transparent material, such as transparent glass, or made of semi-flexible transparent material, such as polyimide. The color filter layer CF includes a plurality of color filter blocks, such as the red filter block CF1 and the green filter block CF2 shown in FIG. 4. Each of the color filter blocks respectively corresponds to one of the sub-pixel units 011, and the color filter layer CF is configured to enable the liquid crystal display panel 01 to realize color display. The common electrode 12 is disposed on the color filter layer CF and covers an entire display region of the liquid crystal display panel 01, and is configured to provide an electric field effect for the liquid crystal deflection in the liquid crystal layer 30. Alternatively, the common electrode 12 is made of a transparent conductive material, such as indium tin oxide, etc. When the liquid crystal display panel 01 performs the display function, the common electrode 12 is powered by an external power source to provide a constant electric field effect on the liquid crystal layer 30.

The second substrate 20 includes a second base substrate 21, a side of the second base substrate 21 facing the first substrate 10 is provided with a thin film transistor layer 23 and a pixel electrode layer 28 provided on the thin film transistor layer 23. The pixel electrode layer 28 includes a plurality of pixel electrodes 281 arranged in an array, an auxiliary electrode 26 is provided in a region between adjacent pixel electrodes 281, and the auxiliary electrode 26 is configured to shield an electric field generated by the thin film transistor layer 23.

It should be noted that the thin film transistor layer 23 includes multiple electronic components and traces, and is electrically connected to the pixel electrode layer 28 for controlling the electric field of the pixel electrode layer 28. The pixel electrode layer 28 provides an electric field effect on the liquid crystal layer 30, and controls the deflection of the liquid crystals in the liquid crystal layer 30 together with the common electrode 12, thereby adjusting the display effect of the liquid crystal display panel 01. The electronic components and traces in the thin film transistor layer 23 are conductive while generating an interference electric field, which causes the electric field generated by the pixel electrode layer 28 to be unstable. As a result, the deflection of the liquid crystals at a junction between two adjacent pixel electrodes 281 is chaotic, and the display contrast ratio of the liquid crystal display panel 01 decreases. In the present embodiment, by providing the auxiliary electrode 26 between the adjacent pixel electrodes 281, the electric field generated by the thin film transistor layer 23 can be shielded to improve the display contrast ratio of the liquid crystal display panel 01.

Alternatively, the second base substrate 21 can be made of a hard transparent material such as glass, or a flexible transparent material such as polyimide.

The thin film transistor layer 23 is disposed on the second base substrate 21 and includes a plurality of data lines 231, a plurality of scan lines 232, and a plurality of thin film transistors 233. The data lines 231 and the scan lines 232 are electrically connected to the thin film transistors 233, respectively. Specifically, each of the thin film transistors 233 includes a gate, a gate insulating layer 22, an active layer, and a source-drain layer. Wherein, the scan lines 232 are electrically connected to the gates of the thin film transistors 233 to provide scan control signals for the thin film transistors 233. The data lines 231 are electrically connected to sources of the thin film transistors 233 to provide data signals for the thin film transistors 233, and drains of the thin film transistors 233 are electrically connected to the pixel electrodes 281. Alternatively, each of the sub-pixel units 011 is correspondingly provided with one of the thin film transistors 233. The scan lines 232 and the gates of the thin film transistors 233 are all positioned on a first metal layer close to the second base substrate 21, and the data lines 231, the sources and the drains of the thin film transistors 233 are all disposed on a second metal layer away from the second base substrate 21.

Furthermore, a passivation layer 24, an organic planarization layer 25, the auxiliary electrode 26, and a transparent insulating layer 27 are further provided between the thin film transistor layer 23 and the pixel electrode layer 28. Wherein, the passivation layer 24 and the transparent insulating layer 27 are both made of a transparent insulating material, such as silicon nitride, silicon oxide, etc. The passivation layer 24 is provided on the thin film transistor layer 23 to play the role of electrical insulation. The organic planarization layer 25 is provided on the passivation layer 24, and is configured to form a flat surface so that other devices can continue to be disposed on the organic planarization layer 25. The auxiliary electrode 26 and the transparent insulating layer 27 are disposed on the organic planarization layer 25, and the transparent insulating layer 27 completely covers the auxiliary electrode 26. The pixel electrode layer 28 is disposed on the transparent insulating layer 27 or the organic planarization layer 25.

The auxiliary electrode 26 is disposed in a region between two adjacent pixel electrodes 281, and is set along regions where the data lines 231, the scan lines 232, and the thin film transistors 233 are positioned to completely cover the data lines 231, the scan lines 232, and the thin film transistors 233. It should be understood that during a display process of the liquid crystal display panel 01, an upward electric field effect generated by the data lines 231, the scan lines 232, and the thin film transistors 233 due to energization will be shielded by the auxiliary electrode 26. Therefore, the influence of the electric field on the pixel electrode 281 is eliminated, and the display contrast ratio of the liquid crystal display panel is improved.

Alternatively, a vertical projection of the auxiliary electrode 26 on the pixel electrode layer 28 and the pixel electrodes 281 only partially overlap at edges, or completely do not overlap. It should be understood that when the vertical projection of the auxiliary electrode 26 on the pixel electrode layer 28 and the pixel electrodes 281 partially overlap at the edges, the auxiliary electrode 26 can completely shield the interference electric field generated by the thin film transistor layer 23. When the vertical projection of the auxiliary electrode 26 on the pixel electrode layer 28 and the pixel electrodes 281 completely do not overlap, the auxiliary electrode 26 plays a role of shielding the electric field, while eliminating its influence on the light transmittance of regions of the pixel electrodes 281.

Alternatively, the transparent insulating layer 27 can be provided only in a region where the auxiliary electrode 26 is positioned, without covering or partially covering a region where the pixel electrodes 281 are positioned; or the transparent insulating layer 27 completely covers an entire display region of the liquid crystal display panel 01.

Alternatively, the organic planarization layer 25 may not be provided on the passivation layer 24, and the auxiliary electrode 26 and the transparent insulating layer 27 can be directly provided on the passivation layer 24, to simplify an interlayer structure of the liquid crystal display panel 01.

Furthermore, the liquid crystal display panel 01 further includes a backlight module provided on a back side of the liquid crystal display panel for providing a light source for the liquid crystal display panel 01.

In summary, the liquid crystal display panel according to the embodiments of the present application includes a first substrate, a second substrate, and a liquid crystal layer disposed therebetween. Compared with the conventional art, the light-shielding layer structure in the first substrate is removed. Meanwhile, an auxiliary electrode is added to the second substrate, and the auxiliary electrode is configured to shield the electric field of the thin film transistor layer in the second substrate, so that the liquid crystal display panel has better light transmittance and aperture ratio while maintaining high contrast ratio.

Embodiments of the present invention have been described, but not intended to impose any unduly constraint to the appended claims. For a person skilled in the art, any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A liquid crystal display panel, comprising a first substrate, a second substrate disposed opposite to the first substrate, and a liquid crystal layer disposed between the first substrate and the second substrate;
wherein the first substrate comprises a first base substrate, and a common electrode disposed on the first base substrate and facing the second substrate;
wherein the second substrate comprises a second base substrate, a side of the second base substrate facing the first substrate is provided with a thin film transistor layer and a pixel electrode layer provided on the thin film transistor layer, the pixel electrode layer comprises a plurality of pixel electrodes arranged in an array, an auxiliary electrode is provided in a region between adjacent pixel electrodes, and the auxiliary electrode is configured to shield an electric field generated by the thin film transistor layer.

2. The liquid crystal display panel according to claim 1, wherein the first base substrate is made of a hard transparent material or a flexible transparent material.

3. The liquid crystal display panel according to claim 1, wherein the common electrode covers an entire display region of the liquid crystal display panel and is configured to provide an electric field effect for liquid crystal deflection in the liquid crystal layer.

4. The liquid crystal display panel according to claim 1, wherein the auxiliary electrode is disposed between the thin film transistor layer and the pixel electrode layer.

5. The liquid crystal display panel according to claim 4, wherein a transparent insulating layer is provided between the auxiliary electrode and the pixel electrode layer.

6. The liquid crystal display panel according to claim 5, wherein the transparent insulating layer is provided only in a region where the auxiliary electrode is positioned, without covering or partially covering a region where the pixel electrodes are positioned.

7. The liquid crystal display panel according to claim 5, wherein the transparent insulating layer completely covers an entire display region of the liquid crystal display panel.

8. The liquid crystal display panel according to claim 1, wherein a color filter layer is provided between the thin film transistor layer and the pixel electrode layer, and the auxiliary electrode is provided between the color filter layer and the pixel electrode layer.

9. The liquid crystal display panel according to claim 8, wherein the color filter layer is provided with a plurality of color filter blocks arranged in an array, the color filter blocks correspond one-to-one with the pixel electrodes, and the auxiliary electrode is disposed in a region between adjacent color filter blocks.

10. The liquid crystal display panel according to claim 8, wherein an organic planarization layer is provided on a side of the color filter layer facing the pixel electrode layer, and the auxiliary electrode is provided between the organic planarization layer and the pixel electrode layer.

11. The liquid crystal display panel according to claim 1, wherein the first substrate further comprises a color filter layer disposed between the first base substrate and the common electrode, the color filter layer comprises a plurality of color filter blocks arranged in an array, and the color filter blocks correspond one-to-one with the pixel electrodes.

12. The liquid crystal display panel according to claim 1, wherein the thin film transistor layer comprises a plurality of thin film transistors arranged in an array, and a plurality of scan lines and a plurality of data lines electrically connected to the thin film transistors.

13. The liquid crystal display panel according to claim 12, wherein the scan lines are electrically connected to gates of the thin film transistors to provide scan control signals for the thin film transistors, respectively, the data lines are electrically connected to sources of the thin film transistors to provide data signals for the thin film transistors, respectively, and drains of the thin film transistors are electrically connected to the pixel electrodes, respectively.

14. The liquid crystal display panel according to claim 13, wherein the scan lines and the gates of the thin film transistors are all positioned on a first metal layer close to the second base substrate, and the data lines, the sources, and the drains of the thin film transistors are all disposed on a second metal layer away from the second base substrate.

15. The liquid crystal display panel according to claim 12, wherein the auxiliary electrode covers the thin film transistors, the scan lines, and the data lines along a thickness direction of the liquid crystal display panel.

16. The liquid crystal display panel according to claim 1, wherein a vertical projection of the auxiliary electrode on the pixel electrode layer and the pixel electrodes only partially overlap at edges, or completely do not overlap.

17. The liquid crystal display panel according to claim 1, wherein the auxiliary electrode is made of a transparent conductive material.

18. The liquid crystal display panel according to claim 1, wherein the liquid crystal display panel further comprises a backlight module provided on a back side of the liquid crystal display panel for providing a light source for the liquid crystal display panel.

19. A liquid crystal display panel, comprising a first substrate, a second substrate disposed opposite to the first substrate, a liquid crystal layer disposed between the first substrate and the second substrate, and a backlight module;
wherein the first substrate comprises a first base substrate and a common electrode disposed on the first base substrate and facing the second substrate;
wherein the second substrate comprises a second base substrate, a side of the second base substrate facing the first substrate is provided with a thin film transistor layer and a pixel electrode layer provided on the thin film transistor layer, the pixel electrode layer comprises a plurality of pixel electrodes arranged in an array, an auxiliary electrode is provided in a region between adjacent pixel electrodes, the auxiliary electrode is disposed between the thin film transistor layer and the pixel electrode layer, the auxiliary electrode is configured to shield an electric field generated by the thin film transistor layer, and a transparent insulating layer is provided between the auxiliary electrode and the pixel electrode layer; and
wherein the backlight module is disposed on a side of the second substrate away from the first substrate, and is configured to provide a light source for the liquid crystal display panel.

20. The liquid crystal display panel according to claim 19, wherein the thin film transistor layer comprises a plurality of thin film transistors arranged in an array, a plurality of scan lines and a plurality of data lines electrically connected to the thin film transistors, respectively, and the auxiliary electrode covers the thin film transistors, the scan lines, and the data lines along a thickness direction of the liquid crystal display panel.
